(19) United States
(12) Patent Application Publication
(10) Pub. No.: US 2010/0290034 A1
(43) Pub. Date: Nov. 18, 2010

(54) Inspection Lamp and Method for Facilitating Rapid Paper Currency Examination and Authentication

(76) Inventor: Craig A. Thompson, Forest Lake, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 12/467,674

(22) Filed: May 18, 2009

(51) Int. Cl. G06K 9/74

(52) U.S. Cl. 356/71

(57) ABSTRACT

A currency inspection instrument has a housing with upper and lower ends, a front and rear portion and a light source is provided at or near the lower end of the housing to direct light upwardly. A light shield is provided as a part of the housing between the light source and the user. A rearward facing reflector is provided inside a front portion of the light shield and forward facing reflector is provided at the rear of the housing above the shield. An inclined elliptical stage is defined by the upper edge of the shield and by the upper end of the forward facing reflector so as to orient or support the paper currency that is to be inspected. In accordance with the method of the invention, a positionable light source is provided. A shield is located between the light source and the eye of the observer. A diffuse light reflector is provided on the opposite side of the light source from the observer and an inclined opening comprising an edge of the shield and the diffuse light reflector is provided as an upper edge of the housing to define a forwardly facing inspection stage for the currency being examined. The housing of the instrument is positionably supported and during use is raised or lowered or tipped about a horizontal axis toward or away from the observer so that the light source is not in the line of sight to prevent the light from the source from shining directly into the eyes of the user while currency is being examined.

### FIELD OF THE INVENTION

This invention relates to optical instruments and to a method for visual examination and detection of counterfeit money.

### BACKGROUND OF THE INVENTION

In recent years, counterfeiting has become a much more serious concern. Advanced copying technologies have helped raise the incidence of counterfeiting. Ink jet printers, color copiers, and scanners are just a few tools criminals use to create bogus bills. Beginning in 1996, the U.S. government has been adding advanced security features consisting of watermarks and security thread to paper currency; the first major design change since 1982.

In keeping with the strategy of maintaining the security of our currency by enhancing currency designs every 7-10 years, a new series of U.S. currency is being issued, beginning with the $20 note which entered circulation on Oct. 9, 2003, followed by the $50 note which was issued on Sep. 28, 2004. The redesigned $10 note entered circulation on Mar. 2, 2006. The redesigned $5 note entered circulation on Mar. 13, 2008. The $100 note is also slated to be redesigned, but a timetable for its introduction is not yet set.

Currency inspection equipment now available is expensive to produce. Most if not all instruments now being sold for the detection of counterfeit bills require lenses or other optical elements and sometimes complicated electronic circuitry as well as lighting that is able to show embedded security threads that glow a different color for each denomination. Lenses and optical elements are both costly and subject to breakage. Electronic circuitry adds further to the cost of the equipment. Generally, prior devices consist of a good sized metal box that is typically placed on a counter next to the cash register. This takes up space otherwise available as a part of the work area for the clerk or cashier. On the other hand, if an overhead lamp is used to illuminate a bill, customers are occasionally offended when they see their currency being examined. For a bill inspection instrument to be effective, it is also necessary to provide brilliant, even illumination free from bright spots and of sufficient intensity to overcome the light furnished by overhead room lighting.

While inexpensive pen-styled detectors have been developed, they are very limited in their effectiveness. Besides being time-consuming to use, they are not able to detect certain features of bleached bills which are produced by illegally defacing bills. For example, pen-style detectors cannot detect a watermark or a security thread of a lower denomination bill that has been bleached and reprinted to a higher denomination. An important objective of the present invention is to be able to illuminate bills effectively enough to enable the watermark and security thread to be clearly visualized so that counterfeit bills can be reliably detected.

### OBJECTS

In view of these and other deficiencies of the prior art, it is one object of the present invention to provide a counterfeit bill detection instrument that is low in cost, simply constructed, has no internal moving parts, lenses or other transparent optical elements and yet is highly effective in facilitating authentication of paper currency.

Another object is to provide a detection instrument of the type described that takes up very little counter space, can accommodate people of different heights, is capable of being positioned in such a way that the instrument can be easily oriented to prevent light from shining directly from a light source into the eye of the user, yet will brightly illuminate the bills that are being inspected.

Still another object is to provide a compact counterfeit bill detection lamp that is effective even though its cross-section is less than the width of a bill that is to be inspected.

Another object of the invention is to provide a highly effective currency inspection instrument that will concentrate light from a light source to a locus where the bills can be placed for inspection and will shine through soiled, old or worn currency without the need of lenses or other transparent glass or plastic optical elements.

A further object of the invention is to provide a currency illumination instrument and method that is convenient and facilitates rapid inspection without having to set the bills down as well as enabling several bills to be examined at the same time.

Another object of the invention is to provide an inspection lamp that enables bills to be examined discretely so that retail customers are not aware that an examination is taking place.

Yet another object is to provide an inexpensive bill inspection lamp that provides bright illumination with little heat so that the operator will not be accidentally burned if the instrument is touched, produces no harmful UV light, yet is of such a small size that it takes up little of the workspace next to a cash register.

These and other more detailed and specific objects and advantages of the present invention will be better understood by reference to the following figures and detailed description which illustrate by way of example but a few of the various forms of the invention within the scope of the appended claims.

### BRIEF DESCRIPTION OF THE DRAWINGS

FIG. 1 is a perspective view showing the invention in use;

FIG. 2 is a side elevation on a larger scale showing how an inspection lamp according to the invention is positioned for use by the operator;

FIG. 3 is a partial vertical sectional diagrammatic view to show the reflection of light rays from light sources within the instrument;

FIG. 4 is a diagrammatic perspective view of the invention partly in section to show how paper currency is inspected;

FIG. 5 is a plan view of the instrument;

FIG. 5A is a plan view showing the inside surface of a tubular upper part of the instrument opened and laid flat; and

FIG. 6 is a side elevational view partly in section to show typical dimensions of the instrument.

### SUMMARY OF THE INVENTION

In the development of the invention, it was found that if any ordinary rectangular box were used to hold a light source, the box had to be quite large to illuminate one or several bills fanned out and held by one hand. However, a major objective of the invention was to find a way to inspect bills with a much smaller device which could be manufactured and shipped inexpensively while still providing illumination over a large area with at least one dimension as large as the width of one bill which is about 2⅝ inches for U.S. currency even though the cross-section of the instrument is smaller, say only 1¼ inches. It was also considered important to find a way to illuminate, support and inspect currency without the need for glass or plastic lenses as already noted. In the course of developing the invention, it was discovered that both of these objectives could be achieved by providing the housing that had a tubular portion above a light source which is as little as 1¼ inches in diameter with an inclined stage for the currency at an upper end of the housing that intersects the axis of the housing at a substantial oblique angle, for example at an angle of 45° to the longitudinal axis of a tubular housing. In this way, the obliquely cut end of the housing serves as a stage to orient or support for the bills as they are inspected and provides an illuminated field, extending along the long axis of an ellipse defined by the cut edge of the cylinder which is long enough, typically 2 to 2¾ inches long so as to extend the width of the bill being inspected. Thus, a small instrument according to the invention is still able to make possible the inspection of much larger bills through the cooperative interaction of the features just described, most preferably, together with a shield defined by a portion of the tubular housing below the obliquely oriented stage that has a rearwardly facing reflector on its inner surface for reflecting light onto a forwardly facing reflector on an inner surface of at least an upper portion of the housing which extends above the shield at the rear of the housing. It was found that these provisions would furnish intense illumination throughout the entire width of a bill without objectionable uneven lighting or bright areas, thereby enabling counterfeit bills to be quickly inspected and reliably detected by means of a compact lighting instrument that is smaller in cross-section than the width of the bill being examined.

Briefly, the present invention provides a currency inspection instrument that includes a housing having upper and lower ends, a front portion placed closest to the user and a rear portion further away from the user. A light source is provided near the lower end of the housing for directing light upwardly. A light shield is provided as a part of the housing between the light source and the user. A rearward facing reflector is provided inside a forward portion of the light shield and forward facing reflector is provided at the rear of the housing above the shield. The upper edge of the shield and the upper end of the forward facing reflector define an inclined supporting stage for the paper currency that is to be inspected. An inspection method in accordance with the invention includes the steps of providing a positionable light source, providing a shield between the light source and the eye of the observer, providing a diffuse light reflector on the opposite side of the light source from the observer and a stage that comprises an inclined upper edge of the shield and the diffuse light reflector around an opening at the top of the housing to define an inspection port for the currency that is to be examined. The housing of the instrument is positionably supported for being raised or lowered during use or tipped about a horizontal axis either toward or away from the observer so that the light source is not in the line of sight to thereby prevent light from the source from shining directly into the eye of the user.

### DETAILED DESCRIPTION OF THE PREFERRED EMBODIMENTS

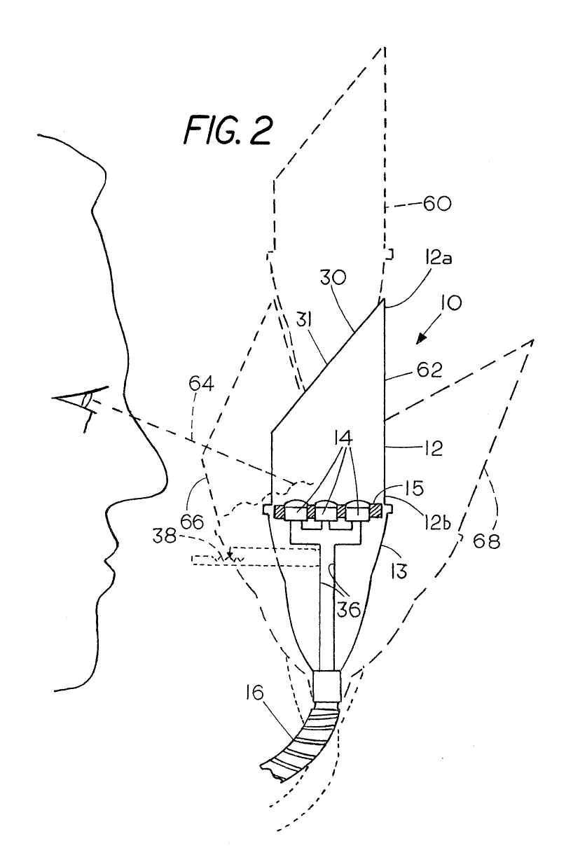

As shown in the figures, the invention comprises an inspection instrument indicated generally at 10 having a hollow housing 12 containing at least one light source near its lower end 12b. In this case, three light sources that are preferably light-emitting diodes (LEDs) 14 are provided within the housing facing upwardly so as to direct light toward an upper end 12a of the housing. The housing 12 can be a tube formed, for example, from metal or plastic, most preferably of oval or circular cross-sectional shape with an opening 30 at its upper end. The housing 12 is connected to the upper end of a positionable mounting stand comprising a flexible conduit or gooseneck 16 that can be repositioned by hand to any selected position and will then remain where it is placed. The conduit has a clamp 18 at its lower end which can be fastened to the edge of a work counter or table 20 usually adjacent to a cash register 22 and computer keyboard 24 having a display 26. The conduit 16 can be of any length desired, for example, between about 6 in. to one foot or more in length but should be long enough so that it can be raised or lowered as well as being tipped forwardly or rearwardly about a horizontal axis as will be described in more detail in connection with FIG. 2. One or more fasteners, such as a screw 19, can be used to secure the base of the stand 16 to the counter 20. Connected between the housing 12 and the conduit 16 is a casing 13 for enclosing electrical wiring.

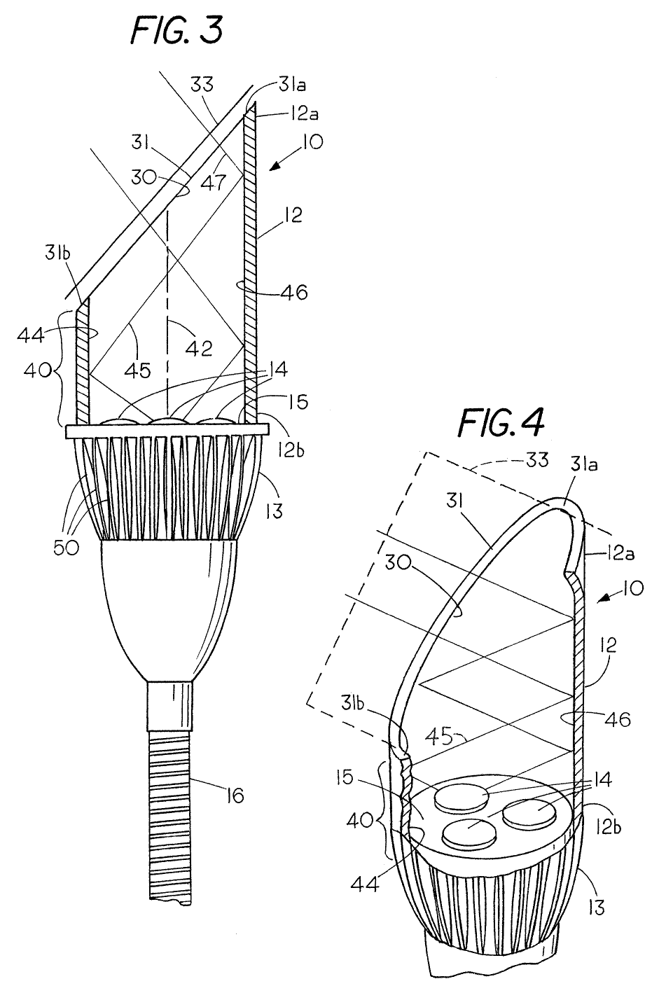

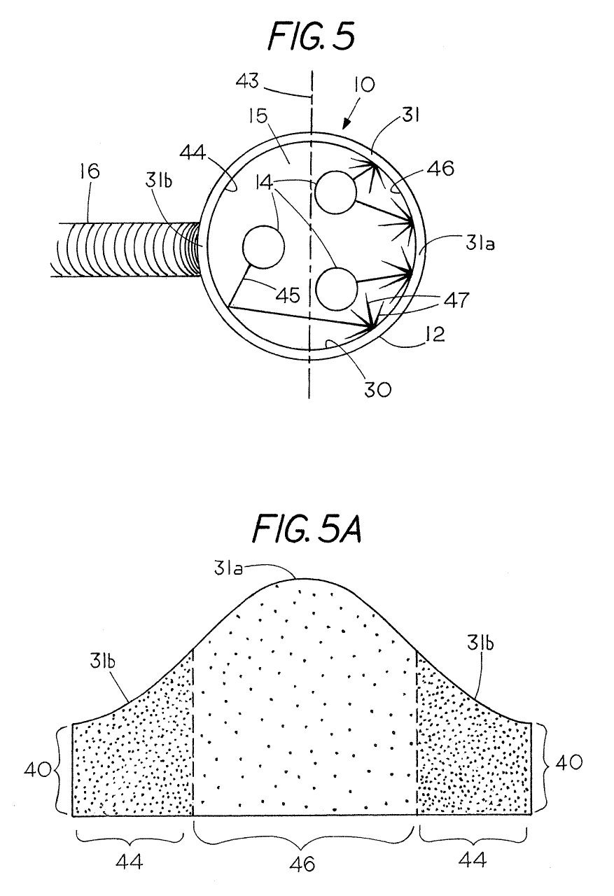

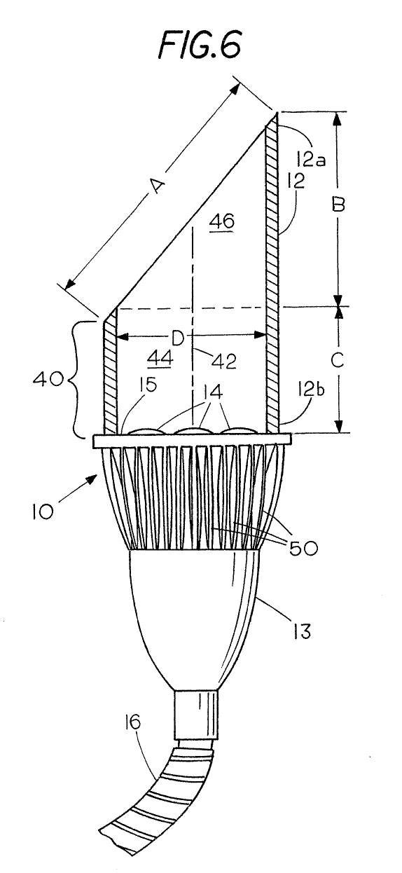

While any of a variety of light sources can be used, it has been found that outstanding results can be obtaining by providing three LEDs mounted on a supporting plate 15 and powered by 110 volts A.C. via power cord 34. The LEDs together preferably provide a light output of about 100 lumens. It was found that excellent results in permitting visualization of watermarks and security threads even in bleached bills could be obtained with three LEDs which together produce light intensity of 100 lumens consisting of 15 watts daylight white or 13 watts or warm white light. One suitable LED source are three LEDs rated at 3 watts, each a one watt Nichia high power LED available from The LED Light, Inc. of Carson City, Nev. Although not preferred, a variety of other suitable light sources can be used, such as an LEP (light emitting plastic) incandescent lights and gas discharge lamps. The LEDs can be arranged in a circle or triangular configuration as shown in FIG. 5. Electrical conductors 36 for supplying power to the light sources 14 (FIG. 2) pass through the conduit to the power cord 34. Numeral 38 designates an optional proximity switch or a variable resistance or other suitable dimmer for regulating the intensity of the light from the LEDs 14. The proximity switch 38 closes to turn on the LEDs 14 each time currency is brought into proximity with the instrument. The lower portion of the housing 12b can be provided with cooling fins 50 if desired to dissipate heat from the light sources (FIGS. 3 and 6).

It will be seen that the opening 30 at the top of the housing has a peripheral edge typically about ⅛ inch in width which acts as a stage 31 for bills 33 that are to be examined. It can be seen that the stage 31 is at an inclined angle θ typically of about 30°-60° most preferably about 40°-50°, e.g. 45° to a vertical central axis 42 of housing 12. A lower portion of the housing 12 indicated by the number 40 comprises a light shield typically 1-2 inches in height to shield the user from light coming directly from the light source 14 so as to obscure the light source from the user (FIG. 2).

The operation of the lamp can best be explained by considering light striking a rear portion of the housing to the right of its central axis 42 and a front portion to the left of the axis 42 as shown in FIGS. 3, 5 and 5A. Inside the forward portion of the tubular housing 12 to the left of the axis 42 is a rearwardly facing reflective surface 44 for reflecting rays, such as 45 onto a forwardly facing diffuse light reflective surface 46 in the rear portion of the tubular housing to the right of the midline at axis 42 as seen in FIG. 3. While the reflective surface 44 facing rearwardly could be either a diffuse light or a specular reflector, i.e. a shiny surface, a highly polished mirror-like, i.e. specular reflector of the kind that reflects an image was found to produce bright spots that were considered unacceptable. A white painted surface or a surface having a bright off-white hue for both 44 and 46 is usually acceptable however. While the exact spectral power distribution can be varied, the most preferred for both the surface 44 facing rearwardly as well as the surface 46 facing forwardly is a reflective surface that reflects diffuse light, such as a white surface which encompasses any of various whites either painted, having a pigmented coating or part of a plastic composition, for example, or a satin-finish metal surface for providing a high level of brightness. Excellent results have been achieved using a housing 12 formed from aluminum tubing having an interior satin-finished aluminum surface. The satin finish can be obtained, for example, by abrading the inside surface of the aluminum tubing using a 600 grit sandpaper. Thus, in FIG. 5, a ray 45 reflected from the rearwardly facing reflective surface 44 inside the shield 40 will strike the diffuse light reflecting surface 46 which scatters the light producing a multiplicity of rays of diffuse light indicated by the several rays 47 which are reflected forwardly out through the oblique opening 30 at the top of the housing 12 surrounded by the currency stage 3 for backlighting the currency 33 as shown in FIGS. 3 and 4.

FIG. 5A is a flattened interior plan view of the tube 12 opened for showing its inner surface including the rearwardly facing reflective surface 44 that is preferably a diffuse light reflector and the forwardly directed diffuse light reflective surface 46 at the rear of the housing 12. In one preferred form of the invention, the tubular housing 12 consists of an aluminum tube of about 1¼ inches to 2 inches in diameter with its upper end cut at a 45° angle to its longitudinal axis 42 and its lower end secured or integral with the lower portion of the housing 12b below the LEDs and a mounting plate 15.

It will be seen that the upper end of top housing 12 is cut in such a way that the opening 30 faces toward the user (FIG. 2) so that the front portion of the housing of the left of the midline 43 (FIG. 5) comprises the front part of the housing and the portion to the right of midline 43 comprises the rear of the housing 12. By terminating the upper open edge or stage 31 of the housing at an oblique angle, not only can the opening 30 be very large, in fact of any length, thus enabling the dimension A (FIG. 6) to be as long as desired, typically from about 2 to about 2¾ inches in length. The dimension B, i.e. the height, above the shield 40 is preferably about 1 to 2 inches and the overall height of the housing above the LEDs 14 is preferably about 3 to 5 inches. The configuration of the housing working with its flexible positionable supporting stand 16 solves several problems at once. First, it shields the user's eyes from intense direct light produced by the LEDs; and, second, it reflects and concentrates light inside the rearwardly facing forward portion of the tube directing it rearwardly onto the diffuse reflector at the rear of the housing 12. Moreover, the forwardly facing rear surface reflects beams of light from the inside front surface 44 and directly from the LED toward the currency that is being examined. It will be seen that the diagonal opening 30 and stage 31 for the currency enables one or more bills to be examined simultaneously even though they have a width of 2 or more inches while the diameter of the tubular housing 12 is only a 1¼ in. or a 1½ in. in diameter. Thus, the oblique opening 30 because it extends downwardly a considerable distance toward the front of the housing 12, exposes a large forwardly facing reflective area 46 at the rear of the housing which is, therefore, able to direct intense scattered, i.e., diffuse illumination onto the rear surface of one or more bills 33 as they are held in the hand of the operator. In this way, a small lamp and housing is able to make possible effective inspection over a large area, for example, the width of 2 or 3 bills that are fanned out and held in one hand.

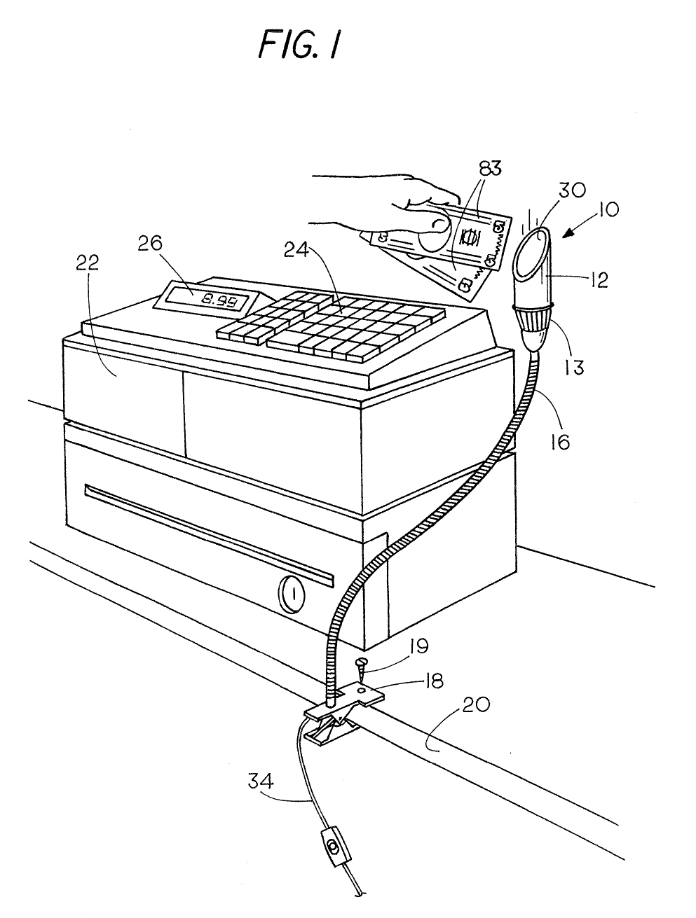

The method of using the invention is best seen in FIGS. 1 and 2. First, the instrument is clamped or otherwise attached to the counter 20. The user then stands or sits next to the counter as shown in FIG. 2. The instrument 10 which is positionably supported on the flexible conduit 16 is then lowered from the position 60 to the position 62 and remains where it is placed by the user in the most convenient position for inspection without the LEDs being in the direct line of sight as shown at 64 in FIG. 2. However, if the LEDs can be seen, for example, when the housing 12 is tipped forwardly about a horizontal axis to the position 66, one or more of the LEDs may become visible which makes inspection difficult or impossible because the light will then shine directly into the eyes of the user. To prevent this, the housing can be tipped rearwardly about a horizontal axis, for example, to the position 62 or 68 until it is positioned so that none of the light sources 14 can be seen by the user. One or more bills which are placed over the opening 30 above the stage 31 will then be brightly backlighted by the light reflected from surface 46 and can be quickly inspected for color, watermark, security thread or strip pointing detail and other characteristics so that the validity of the currency can be authenticated and counterfeit bills detected.

It will be noticed no lenses or other transparent glass or plastic optical elements are required. Nevertheless, the invention provides intense, even backlighting illumination that is free of objectionable bright spots, enabling paper currency and other certificates to be quickly but reliably authenticated. During test runs, it was found that a single bill can be examined in about two seconds. However, by holding several, for or example, three bills in a fanned arrangement in one hand it was found that all three bills could be inspected in about 3-4 seconds. In a retail establishment, bills can usually be authenticated using the invention without customers being aware that they are being examined.

Many variations of the present invention within the scope of the appended claims will be apparent to those skilled in the art once the principles described herein are read and understood.

What is claimed is:

1. An instrument for examining and authenticating paper currency comprising, a housing having upper and lower portions, a light source in a lower portion of the housing, a light shield as a forward part of the housing for being placed between the light source and the user, a rearwardly facing reflective surface inside the light shield at the forward part of the housing for reflecting light rearwardly, a forwardly facing light reflective surface on a rear portion of the housing above the shield, an inclined stage defined by an upper edge of the shield and an upper edge of the forwardly facing reflective surface, the stage being adapted to orient or support the paper currency while it is being inspected and a rear portion of the inclined stage projects upwardly above a forward portion of the stage such that the stage surrounds an opening in an upper part of the housing that can be positioned to face toward the user during use so that paper currency placed adjacent to the stage can be inspected for color, watermark, printing details and security thread to facilitate authentication of the currency.

2. The instrument of claim 1 wherein the housing comprises a tube having a central longitudinal axis that is placed in a generally upright position during use and the stage is positioned at an oblique angle to the longitudinal axis of the tubular housing.

3. The instrument of claim 1 wherein the rearwardly facing reflective surface comprises a concave diffuse light reflective surface.

4. The instrument of claim 1 wherein the forwardly facing reflective surface at the rear of the housing comprises a concave diffuse light reflector selected from the group consisting white paint, paint of a light tone and stain-finish metal surface.

5. The instrument of claim 1 wherein the housing of the instrument is tubular, said stage intersects a central longitudinal axis of the tubular housing at an oblique angle between about 30° and 60° from the axis and the light source comprises at least one upwardly directed light source in the lower portion of the housing.

6. The instrument of claim 5 wherein the light source comprises a plurality of laterally spaced apart LEDs supported at the lower portions of said housing.

7. The apparatus of claim 1 wherein the instrument includes a positionable support enabling the housing to be raised, lowered or tipped forwardly or rearwardly about a horizontal axis to a selected position and to remain in the selected position so as to position the shield between the light source and the eyes of the user.

8. A method of inspecting and authenticating paper currency comprising the steps of, providing a positionable light source, providing a shield as a part of a housing for being placed between the light source and the eyes of a user, providing a diffuse light reflector on an opposite side of the light source from the user, providing a stage as a part of the housing above the light source, locating the stage to face the user and to extend on an incline between the shield and the reflector, positioning the light source by raising or lowering the light source or by tipping the light source about a horizontal axis toward or away from the user so that the light source is not in the user's line of sight, thereafter placing one or more pieces of paper currency above the stage and inspecting the currency while being illuminated by light from the light source that is reflected from the forwardly facing diffuse light reflective surface toward the stage to thereby backlight the currency.

9. The method of claim 8 wherein the paper currency is positioned manually by holding an edge thereof to place the paper currency adjacent to the stage between the stage and the eye of the user and providing as the light source at least one LED having an intensity that permits visualization of watermarks and security threads that are present in the paper currency.

10. The method of claim 8 wherein one or more pieces of paper currency are positioned to rest against the stage for supporting the currency during visual inspection by the user.

11. The method of claim 8 wherein a proximity sensor is wired to the light source for turning on the light source each time currency is brought into proximity with the instrument.

12. An instrument for facilitating rapid visual paper currency inspection and authentication comprising, a tubular housing having an upper and a lower end, a light source comprising at least one light emitting diode supported within the housing proximate the lower end thereof, a lower portion of the tubular housing comprising an annular section of the tubular housing defining a shield having a predetermined height for shielding the diode from view by the user during use, the shield having a rearwardly facing inner surface above the diode, the housing having a rear portion which extends substantially above the shield, said rear portion having a forwardly facing inner aspect comprising a light reflective surface selected from a satin-finish metal surface, a white surface and pigmented surface for reflecting diffuse light therefrom, said tubular housing having a free upper edge that is inclined with respect to a central longitudinal axis of the tubular housing at an oblique angle such that the edge extends downwardly toward a forward portion of the housing to act as an oblique viewing stage upon which paper currency that is placed thereon will be brightly backlit by light reflected from said forwardly facing inner surface of the tubular housing and a positionable supporting stand for the housing that enables the housing to be manually moved to and located in a selected position by the user.

13. The instrument of claim 12 wherein the positionable supporting stand comprises a flexible conduit containing electrical conductors to carry current to the light-emitting diode and a mounting base on the lower end thereof for locating the conduit on a base structure.

14. The instrument of claim 12 wherein the stand enables the instrument to be moved vertically or tilted to the selected position.

15. The instrument of claim 12 including a proximity switch conductively wired to the light source for turning on the light source each time currency is brought into proximity with the instrument.
